(19) United States
(12) Patent Application Publication
(10) Pub. No.: US 2006/0044818 A1
(43) Pub. Date: Mar. 2, 2006

(54) Headlight device for vehicle

(75) Inventor: Yoshinori Amagasa, Tokyo (JP)

Correspondence Address: SMITH, GAMBRELL & RUSSELL, LLP, 1850 M STREET, N.W., SUITE 800, WASHINGTON, DC, 20036, US

(73) Assignee: Fuji Jukogyo Kabushiki Kaisha

(21) Appl. No.: 11/216,039

(22) Filed: Sep. 1, 2005

(30) Foreign Application Priority Data
Sep. 2, 2004 (JP) 2004-255665

(51) Int. Cl. F21V 7/00

(52) U.S. Cl. 362/514

(57) ABSTRACT

A vehicle headlight device including a light source whose hue is changeable, and a DRL controller for varying the hue of the light source on the basis of the information of the surroundings of a vehicle and turning on the light source under a predetermined daytime running condition.

### CROSS REFERENCE TO RELATED APPLICATIONS

The disclosure of Japanese Application No. 2004-255665 filed on Sep. 2, 2004 including the specification, drawings and abstract is incorporated herein by reference in its entirety.

### BACKGROUND OF THE INVENTION

1. Field of the Invention

The present invention relates to a vehicle headlight device for controlling a turn-on operation of a predetermined lamp in the daytime.

2. Description of the Related art

In countries such as North America, etc., a driver is obligated to drive his or her vehicle while turning on a headlight device of the vehicle in the daytime. Even in the daytime, visibility of the vehicle from the outside can be enhanced by turning on the headlight which is used as a head lamp in the night, thereby enhancing driving safety of the vehicle. It is a general design that the headlight has a single bulb and emits white or blue light. In our country (Japan), it is not legally obligated, however, if the headlight is turned on in the daytime, an effect on traffic safety would be expected.

As this type of the vehicle headlight device is known a headlight device of varying a brightness of the headlight in accordance with luminance around the vehicle (for example, JP-A-2001-347880). Accordingly, it can be avoided that the visibility of the vehicle from the outside becomes insufficient because the brightness of the headlight is reduced or because excessive brightness of the headlight deprives a driver of a oncoming vehicle or a pedestrian of his or her field of vision.

There is well known such a phenomenon that even in the daytime, a color tone of a surrounding environment of the vehicle is varied and thus the visibility of a human to the headlight is varied in accordance with a time zone like daytime and twilight. Furthermore, the color tone of the surrounding environment of the vehicle is also varied in accordance with a weather or a placeplace, for example, like fine weather and rainy weather or a mountain area and a seacoast area.

The vehicle headlight device can be adjusted in brightness to thereby enhance the visibility, however, it cannot be adjusted in a hue because it emits a light with a single hue. Accordingly, when the color tone of the surrounding environment of the vehicle is inconvenient to the visibility of a bulb, the brightness of the bulb is increased or the like to take a countermeasure to the above inconvenience. However, this countermeasure cannot fundamentally enhance the visibility. Furthermore, in connection with some brightness of the vehicle surrounding environment, there is a case where the visibility cannot be so enhanced even by varying the brightness of the bulb unless the hue is changed.

### SUMMARY OF THE INVENTION

The present invention has been implemented in view of foregoing situations, and has an object to provide a vehicle headlight device that can vary a hue of a light source in accordance with surrounding environments of a vehicle.

In order to attain the above object, the vehicle headlight device according to a first aspect of the present invention comprises a light source with a changeable hue, a hue varying unit for varying the hue thereof on the basis of information of the surroundings of a vehicle, and a daytime turn-on control unit for turning on the light source under a predetermined daytime running condition.

According to the first aspect of the present invention, the light source is turned on under the daytime running condition by the daytime turn-on control unit, and pedestrians and drivers of ongoing vehicles can visually identify the light source emitting a light. At this time, the hue of the light source is varied on the basis of information of the surroundings of the vehicle, and thus the light source is made to emit the light with the hue which is conspicuous to the surrounding environment of the vehicle. That is, the light source emits the light with the hue which is excellent in visibility, and thus the drivers and the pedestrians can surely recognize an existence of the vehicle, so that the safety related to the traffic can be remarkably enhanced.

According to a second aspect of the present invention, the vehicle headlight device of the first aspect further comprises a color tone detecting unit for detecting the color tone of the surroundings and the information of the surroundings thereof contains the information concerning the color tone detected by the color tone detecting unit.

According to the vehicle headlight device of the second embodiment, in addition to a function of the first aspect, the hue of the light source is varied in accordance with the color tone of the surrounding environment of the vehicle. Accordingly, the light source can be made to emit light with the hue which is conspicuous to the color tone of the surrounding environment of the vehicle.

According to a third aspect of the present invention, in the vehicle headlight device of the first aspect of the present invention, the information of the surroundings contains the information concerning a date and a hour.

According to the vehicle headlight device of the third aspect, in addition to the function of the first aspect of the present invention, the hue of the light source is varied in accordance with the data and hour. Accordingly, the light source can be made to emit the light with the hue which is conspicuous in connection with a time zone or season.

According to a fourth aspect of the present invention, in the vehicle headlight device of the first of the present invention, the information of the surroundings contains the information concerning the position of the vehicle.

According to the vehicle headlight device of the fourth aspect, in addition to the function of the first aspect, the hue of the light source is varied in accordance with the position of the vehicle. Accordingly, the light source can be made to emit the light with the hue corresponding to a height of the sun at the longitudinal and latitudinal positions of the vehicle or the hue which is conspicuous to surrounding scenery or the like.

According to a fifth aspect of the present invention, in the vehicle headlight device of the first aspect of the present invention, the light source has a plurality of light emitting portions for emitting the light with a different hue, and the hue varying unit controls a color mixing state of the respective light emitting portions to vary the hue of the light source According to the vehicle headlight device of the fifth aspect, in addition to of the first aspects, the light emission degree of each light emitting portion is varied to vary the color mixing state of primary color light from the respective light emitting portions, so that the hue of the light source is varied. Accordingly, the hue of the light source can be easily varied by controlling the light emission degree of each light emission portion.

According to a sixth aspect of the present invention, the vehicle headlight device of the first aspect further comprises a brightness detecting unit for detecting a brightness of the surrounding environment of the vehicle, and a light amount varying unit for varying the light amount thereof on the basis of the brightness detected by the brightness detecting unit.

According to the vehicle headlight device of the sixth aspect, in addition to the function of the first aspects, the light amount of the light source is varied in accordance with the brightness of the surrounding environment of the vehicle. Accordingly, the light source can be made to emit the light with a light amount which is conspicuous to the brightness of the surrounding environment of the vehicle.

According to a seventh aspect of the present invention, in the vehicle headlight device of the first aspect, the light source is a specific lamp which is turned on only in the daytime.

According to the seventh aspect, in addition to the function of the first aspects, the light source is the specific lamp which is turned on only in the daytime, and thus the lamp control can be relatively easily performed.

According to an eighth aspect of the present invention, the vehicle headlight device according to the first aspects further comprises a lamp turn-on control unit for prohibiting the operation of the daytime turn-on control unit when a predetermined lamp is turned on, and turning on the light source as the specific lamp.

According to the eighth aspect of the present invention, in addition to the function of the first aspects, when the light source is turned on the predetermined lamp of the headlight by the lamp turn-on control means, the operation of the daytime turn-on control unit is prohibited even under the daytime turn-on condition, and the light source is turned on as the specific lamp. At this time, the light source is turned on with the hue of the specific lamp.

Accordingly, the light source is used as the specific lamp in principle, and it is turned on by the daytime turn-on control unit under the state that it is not used as the specific lamp under the daytime running condition.

According to a ninth aspect of the present invention, in the vehicle headlight device of the eighth aspect, the specific lamp is a clearance lamp.

According to the ninth aspect, in addition to the function of the eighth aspect, the light source functions as the clearance lamp in principle, and when it is not used as the clearance lamp under the daytime running condition, it is turned on by the daytime turn-on control unit.

According to a tenth aspect of the present invention, in the vehicle headlight device of the eighth aspect, the specific lamp is a turn signal lamp.

According to the tenth aspect of the present invention, in addition to the function of the eighth aspect, the light source functions as a turn signal lamp in principle, and it is turned on by the daytime turn-on control unit under the state that the light source is not used as the turn signal lamp under the daytime running condition.

According to an eleventh aspect of the present invention, in the vehicle headlight device of the eighth aspect, the specific lamp is a low beam head lamp.

According to the eleventh aspect, in addition to the function of the eighth aspect, the light source functions as a low beam head lamp in principle, and it is turned on by the daytime turn-on control unit under the state that it is not used as the low beam head lamp under the daytime running condition.

As described above, according to the vehicle headlight device of the present invention, the hue of the light source can be varied in accordance with the surrounding environment of the vehicle.

### BRIEF DESCRIPTION OF THE DRAWINGS

FIG. 1 is a diagram showing an outlook of a vehicle having a headlight device according to an embodiment of the present invention;

FIG. 2 is a front view showing a headlight portion of the vehicle headlight device;

FIG. 3 is a block diagram showing the structure of the vehicle headlight device;

FIG. 4 is a diagram showing a relationship between a color temperature measured by a color temperature sensor and a color of a light emitted from a light source

FIG. 5 is the diagram showing the relationship between a light amount measured by an illuminance sensor and the light amount of the light source.

FIG. 6 is the block diagram showing the structure of the vehicle headlight device according to a first modification; and

FIG. 7 is the block diagram showing the constructure of the vehicle headlight device according to a second modification.

### DETAILED DESCRIPTION OF THE PREFERRED EMBODIMENTS

Preferred embodiments according to the present invention will be described hereunder with reference to the accompanying drawings.

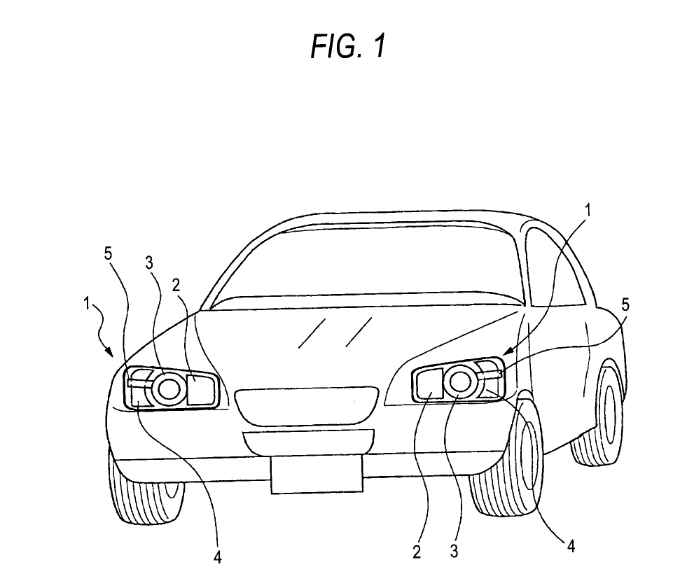

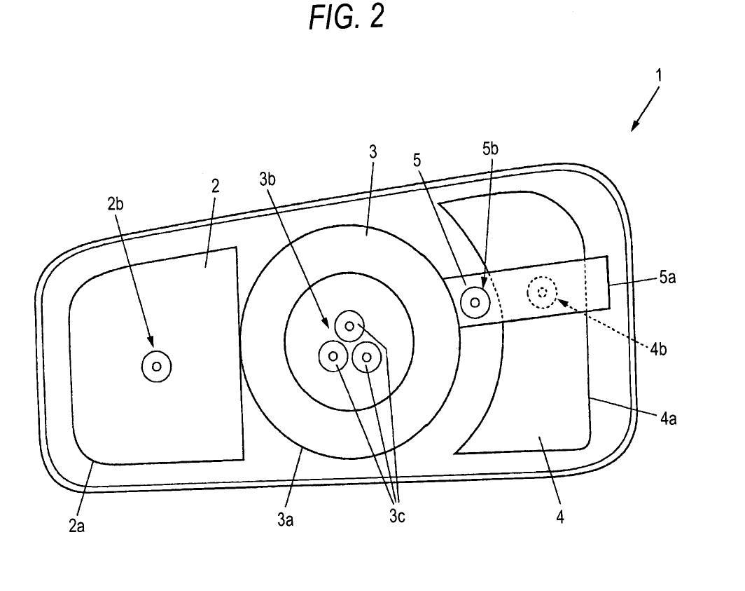

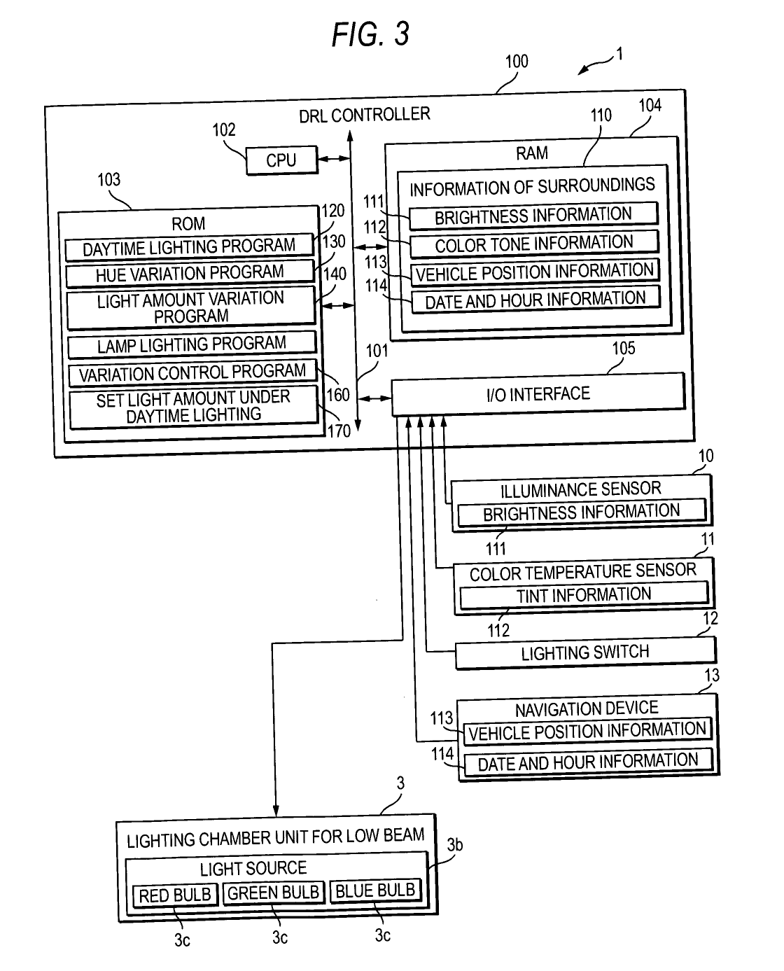

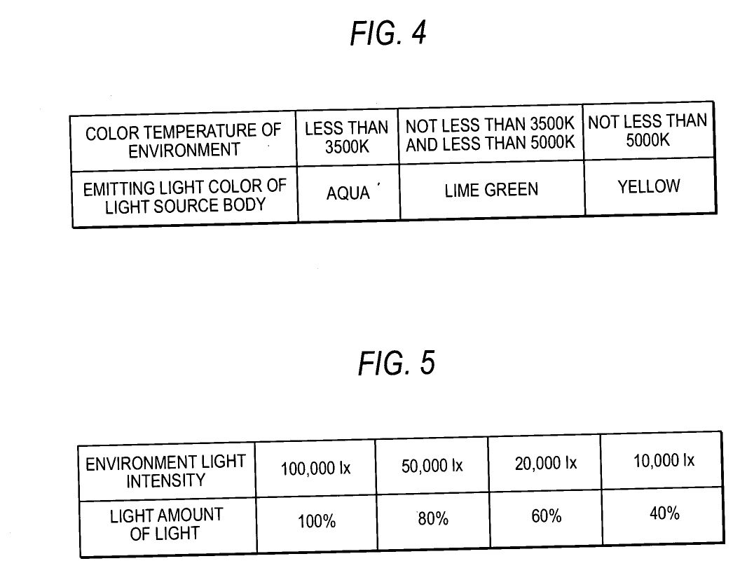

FIGS. 1 to 5 show an embodiment of the present invention, Particularly, FIG. 1 is a diagram showing an outlook of a vehicle equipped with a headlight device, FIG. 2 is a front view showing each headlight portion of the vehicle headlight device, FIG. 3 is a block diagram showing a structure of the vehicle headlight device, FIG. 4 is the diagram showing a relationship between a color temperature measured by a color temperature sensor and a color of a light emitted from a light source, and FIG. 5 is the diagram showing the relationship between a light amount measured by an illuminance sensor and the light amount of the light source.

The vehicle headlight device 1 is equipped to the vehicle so that the headlight portions are located symmetrically at both the right and left sides of the front portion of the vehicle as shown in FIG. 1. As shown in FIG. 2, the vehicle headlight device 1 comprises a light room 2 for high beam, a light room 3 for low beam, a light room 4 for turn signal, and a light room 5 for clearance. In each of the light rooms 2, 3, 4 and 5, each of light source bodies 2b, 3b, 4b and 5b are disposed in each of housings 2a, 3a, 4a and 5a. In this embodiment, the light source 3b of the low-beam light room 3 comprises three bulbs 3c for emitting light with different hues. Each of the light sources 2b, 3b, 4b and 5b of the high-beam light rooms 2, the turn-signal light room 4 and the clearance light room 5 comprises a bulb.

The valves 3c as light emitting portions of the low-beam light room 3 are disposed in proximity to one another and emit a red-color light, a green-color light and a blue-color light, respectively. In FIG. 1, only one valve is provided for every color, however, plural valves may be provided for every color while the size per valve is reduced. Accordingly, when the light emission degree of each bulb 3c is adjusted to vary the color mixing state of the red, green and blue, the hue, color saturation and the brightness of the light source 3b are varied, and the light irradiated from the low-beam light room 3 is varied. That is, the red-color bulb 3c and the green-color bulb 3c are set to the equal turn-on state, and the blue-color bulb 3c is set to the turn-off state, thereby making the light source 3c emit the yellow light. Furthermore, the green-color bulb 3c and the blue-color bulb 3c are set to the equal turn-on state, and the red-color bulb 3c is set to the turn-off state, thereby making the light source 3c emit the light blue (aqua color) light. Furthermore, the blue-color bulb 3c and the red-color bulb 3c are set to the equal turn-on state, and the green-color bulb 3c is set to the turn-off state, thereby making the light source 3c emit a purple light. As described above, when the one-color bulb 3c or the two-color bulbs 3c are made to emit the light, the light source 3c emits the light under a high color-saturation state. Furthermore, when the three-color bulbs 3c are combined with one another, the light source 3c is made to emit the light under a low color-saturation state. When all the bulbs 3c are set to the equal turn-on state, the light source 3b emits a white light.

By varying the amount of a current to be supplied to each bulb 3c or carrying out duty-control on each bulb 3c with a fixed current amount, the light emission degree of each bulb 3c can be varied. In this embodiment, the light emission degree of each bulb 3c is controlled to vary in a stepless mode by a daytime running lamp controller 100, whereby the hue, the color saturation and the brightness of the light source 3b can be freely varied by adjusting a so-called RGB value comprising red, green and blue of the light source 3.

As shown in FIG. 3, the vehicle headlight device 1 has a daytime running lamp controller (hereinafter referred to as “DRL controller”) 100. The DRL controller 100 has CPU 102, ROM 103 and RAM 104 which are connected to one another through a bus 101. Furthermore, the DRL controller 100 is provided with an I/O interface 105 for making communications with external equipments, and the light source 3b of the low-beam light room 3 is connected to the I/O interface 105. That is, in response to an instruction from the DRL controller 100, the light emission state of each valve 3c of the light source 3b is varied, and the switching operation between a turn-on and a turn-off of the light source 3b, and the hue, the color saturation and the brightness under the turn-on state are controlled.

Furthermore, in this embodiment, an illuminance sensor 10 serving as a detecting unit for detecting the brightness of the surrounding environment on the basis of the light amount, and a color temperature sensor 11 serving as a color tone detecting unit for detecting a color tone of the surrounding environment on the basis of the color temperature are connected to the I/O interface 105. The illuminance sensor 10 and the color temperature sensor 11 may be disposed on the upper surface of an instrument panel or the like in the vehicle, or arranged at the outside of the vehicle such as a mount portion of an antenna, a roof rail or the like, for example. A brightness information 111 concerning the brightness detected by the illuminance sensor 10 and color tone information 112 concerning the color tone detected by the color temperature sensor 11 are transmitted to the DRL controller 100.

Furthermore, to the I/O interface 105 are also connected a lighting switch 12 which is mounted on a steering column at a driver's seat and switches the control state concerning the light of the vehicle, and a navigation device 13 which is disposed in the instrument panel and displays the vehicle position, the travel route to a destination, the present time, predicted arrival time, etc. Accordingly, the state of the lighting switch 12 is transmitted to the DRL controller 100, and also the vehicle position information 113, the date and hour information 114, etc. are transmitted from the navigation device 13 to the DRL controller 110. The navigation device 113 receives the vehicle position information 113, the date and hour information 114, etc. from the outside of the vehicle as in the case of the prior art.

In ROM 103 are stored a daytime turn-on program 120 for turning on the light source 3b under a predetermined daytime running condition, the hue varying program 130 for varying the hue of the light source 3b on the basis of information of the surroundings 110 of the vehicle, and a light amount varying program 140 for varying the light amount of the light source 3b on the basis of the brightness of the surrounding environment of the vehicle. That is, in this embodiment, the DRL controller 100 constitutes a daytime turn-on control unit, a hue varying unit and a light amount varying unit. In this embodiment, the information of the surroundings 110 contains brightness information 111, the hue information 112, the vehicle position information 113, the date and hour information 114, etc. Furthermore, in ROM 103 are stored a lamp turn-on program 150 for prohibiting the operation of the daytime turn-on program 120 when the low-beam head lamp is controlled to be turned on, and turning on the light source 3b as the low-beam head lamp. That is, in this embodiment, the DRL controller 100 constitutes the lamp turn-on control unit. Furthermore, a variation suppressing program 160 for suppressing a variation of the light amount of each bulb 3c of the light source 3b is also stored in ROM 103.

In this embodiment, the daytime turn-on program 120 is a program for turning on the light source 3b when the light amount detected by the illuminance sensor 10 is larger than a preset daytime turn-on light amount 170. The hue varying program 130 is the program for controlling the turn-on state of the light source 3b so that the turn-on state has an RGB value calculated on the basis of the information of the surroundings 110. The light amount varying program 140 is the program for controlling the turn-on state of the light source 3b so that the turn-on state has the light amount calculated on the basis of the information of the surroundings 110. Furthermore, the lamp turn-on program 150 identifies whether the state of the lighting switch 12 is a turn-on state under which the low-beam head lamp is turned on, prohibiting the daytime turn-on operation when the state of the lighting switch 12 is the turn-on state concerned and making the light source 3b emit light as the low-beam head lamp. Furthermore, the variation suppressing program 160 is a program for suppressing the hue, the color saturation and the brightness of the light source 3b so that they do not greatly vary when the surrounding environment of the vehicle is accidentally greatly varied.

In this embodiment, the hue varying program 130 adds the RGB value calculated on the basis of the color tone information 112, the RGB value calculated on the basis of the vehicle position information 113, the RGB value calculated on the basis of time information contained in the date and hour information 114, and the RGB value calculated on the basis of season information contained in the date and hour information 114 while subjecting these RGB values to predetermined weighting, thereby calculating the RGB value of the light source 3b to be actually controlled. The hue varying program 130 varies the hue of the light source 3b by controlling the color mixing state of the respective bulbs 3c as described above.

The hue varying program 130 achieves the color tone of the surrounding environment of the vehicle as color tone information 112 on the basis of color temperature, and calculates the RGB value which is symmetrical with the color temperature. In this embodiment, when the color temperature is less than 3500 K. (Kelvin), the RGB value corresponding to light blue (aqua color) is calculated, when the color temperature ranges from 3500 K. to less than 5000 K., the RGB value corresponding to yellow-green, and when the color temperature is not less than 5000 K., the RGB value corresponding to yellow is calculated as shown in FIG. 4. The yellow-green color is implemented by making the green-color bulb 3c emit light and also making the red-color bulb 3d emit light at an intensity lower than the green-color bulb 3c. Accordingly, under clear weather, the light source 3b substantially emits light of aqua blue at dawn, light of yellow-green in the morning, light of yellow in the daytime, light of yellow-green in the evening, and light of aqua blue at sunset.

Furthermore, the hue varying program 130 achieves the longitudinal and latitude of the present position of the vehicle as the vehicle position information 113, and calculates the RGB value corresponding to the longitude and latitude. That is, the height of the sun is specified on the basis of the longitude and the latitude, the variation of the color tone of the surrounding environment caused by the height of the sun is estimated, and the RGB value is varied.

Furthermore, if the longitude and latitude of the vehicle is achieved with high precision to the extent that the surrounding scene can be specified, the RGB value can be varied in connection with the scene. For example, if the vehicle is located in a place along the sea, the color tone of the surrounding environment is estimated to have high degree in blue color, and thus the RGB value symmetrical with this color maybe selected. Furthermore, if the vehicle is located in a place along the mountains, the color tone of the surrounding environment is estimated to have high degree in green color, and thus the RGB value symmetrical with this color may be selected.

The hue varying program 130 achieves the time information and the season information as the date and hour information 114, and calculates the RGB values corresponding to the time information and the season information. That is, with respect to the time information, it is estimated that the color tone of the surrounding environment is bluish white in the daytime, and thus the RGB value symmetrical with this color may be calculated. Furthermore, for example, in the morning or in the evening, it is predicted that the color tone of the surrounding environment is red, and thus the RGB value symmetrical with this color may be calculated.

With respect to the season information, for example, since the position of the sun in the summer season is higher than that in the winter season, the color temperature of the surrounding environment is estimated to be high in the summer season and low in the winter season. Accordingly, the RGB value may be varied in accordance with the height of the sun which varies in accordance with the season. Furthermore, for example, it is estimated that the color tone of the surrounding environment is green-based in the summer season because the leaves of trees are colored, and thus the RGB value symmetrical with this color may be calculated. Still furthermore, it is estimated that the color toner of the surrounding environment is blown-based because the leaves fall down, and thus the RGB value symmetrical with this color may be calculated. For example, when the present position of the vehicle is judged to be in a cold place on the basis of the longitude and latitude of the present position and also it is further judged to be in the winter season, it is estimated that the color tone of the surrounding environment is white because of snow coverage.

Therefore, an RGB value with which the color saturation of the light source 3b is increased may be calculated.

In this embodiment, the light amount varying program 140 adds the light amount calculated on the basis of the brightness information, the light amount calculated on the basis of the vehicle position information 113, the light amount calculated on the basis of the time information contained in the date and hour information 114, and the light amount calculated on the basis of the season information contained in the date and hour information 114 while subjecting these light amounts to predetermined weighting, thereby calculating the light amount of the light source 3b to be really controlled. The variation of the light amount is carried out without varying the hue of the light source 3b, and in this embodiment, it is carried out without varying the relative light emission degree of each bulb 3c.

The light amount varying program 140 achieves the brightness of the surrounding environment of the vehicle as the brightness information 111 in the form of illuminance, and the light amount symmetrical with this illuminance is calculated. In this embodiment, as shown in FIG. 4, the light amount when the illuminance detected by the illuminance sensor 10 is equal to 100,000 lux is preset. The light amount in this case is set as 100%, the light amount when the illuminance is equal to 50,000 lux is set as 80%, the light amount when the illuminance is equal to 20,000 is set as 60%, and the light amount when the illuminance is equal to 10,000 lux is set as 40%.

The light amount varying program 140 achieves the longitude and latitude of the present position of the vehicle as the vehicle position information 113, and the light amount corresponding to the longitude and latitude is calculated. That is, the height of the sun can be specified on the basis of the longitude and latitude, and the light amount is varied while estimating the variation of the illuminance of the surrounding environment which is caused by the height of the sun.

Furthermore, the light amount varying program 140 achieves the time information and the season information as the date and hour information 114, and calculates the light amounts corresponding to the time information and the season information, respectively.

That is, with respect to the time information, it is estimated that the illuminance of the surrounding environment is large in the daytime, and thus a relatively large light amount may be calculated in connection with this estimation. Furthermore, it is also estimated that the illuminance of the surrounding environment is small in the morning or in the evening, and thus a relatively small light amount may be calculated in connection with this estimation.

Furthermore, with respect to the season information, the position of the sun in the summer season is higher than that in the winter season, and thus it is estimated that the illuminance of the surrounding environment is high in the summer season and that in the winter season is low. Accordingly, the light amount of the light source 3b may be varied in accordance with the height of the sun which varies with the season. Furthermore, when it is judged that the present position of the vehicle is in a cold place from the longitude and latitude of the present position and also it is judged that the present season is the winter season, it is estimated that the illuminance of the surrounding environment is high because of diffuse reflection caused by snow coverage, and thus the light amount of the light source 3b may be set to be increased.

According to the vehicle headlight device 1 thus constructureed, the light source 3b is turned on by the DRL controller 100 under the daytime running condition, and pedestrians and drivers of oncoming vehicles visually recognize the light source 3b emitting light. At this time, the hue of the light source 3b is varied on the basis of information of the surroundings 110 of the vehicle by the hue varying program 130, and thus the light source 3b can be made to emit light with hue which is conspicuous to the surrounding environment of the vehicle. That is, since the light source 3b emits light with excellently visible hue, the drivers and the pedestrians can surely recognize existence of the vehicle, and the safety concerning the traffic can be remarkably enhanced.

According to the vehicle headlight device 1 of this embodiment, the hue of the light source 3b is varied in accordance with the color tone of the surrounding environment of the vehicle. Accordingly, the light source 3b can be made to emit light with hue which is conspicuous to the color tone of the surrounding environment of the vehicle. Furthermore, since the hue of the light source 3b is varied in accordance with the date and hour, the light source can be made to emit light with conspicuous hue in conformity with the time zone or the season. Furthermore, since the hue of the light source 3b is varied in accordance with the position of the vehicle, the light source 3b can be made to emit light with the hue corresponding to the height of the sun at the longitude and latitude of the vehicle position or with hue which is conspicuous to the surrounding scene or the like.

According to the vehicle headlight device 1 of this embodiment, the color mixing state of the primary colors of the respective bulbs 3c is varied by varying the light emission degree of each bulb 3c, thereby varying the hue of the light source 3b. Accordingly, by controlling the light emission degree of each bulb 3c, the hue of the light source 3b can be easily and simply varied.

Furthermore, according to the vehicle headlight device 1 of this embodiment, the light amount of the light source 3b is varied in accordance with the brightness of the surrounding environment of the vehicle, and thus the light source 3b can be made to emit light with a light amount which is conspicuous to the brightness of the surrounding environment of the vehicle.

Still furthermore, according to the vehicle headlight device 1 of this embodiment, when the light source 3b is turned on as the low-beam head lamp by the lamp turn-on program 150, the operation of the daytime turn-on program 120 is prohibited even under the daytime turn-on condition, and the light source 3b is turned on as the low-beam head lamp. At this time, the light source 3b is turned on with the hue of the low-beam head lamp.

Accordingly, the light source 3b is used as the low-beam head lamp in principle, and when it is not used as the low-beam head lamp under the daytime running condition, the light source 3b is turned on by the daytime turn-on program 120. As described above, the light source 3b can be commonly used without losing the function of the low beam.

Still furthermore, according to the headlight device 1 of this embodiment, the hue, color saturation and brightness of the light source 3b are prevented from being greatly varied by the variation suppressing program 160 even when the surrounding environment of the vehicle is accidentally and greatly varied. Therefore, even when the illuminance, color tone or the like of the surrounding environment of the vehicle is varied by the neon of street lamps, the headlight of other cars or the like, the hue, color saturation and brightness of the light source 3b can be prevented from greatly varying while following the variation in illuminance, color tone or the like of the surrounding environment. Accordingly, the light source 3b can be made to emit light with precision.

In this embodiment, the low-beam head lamp and the daytime running lamp are common to each other. However, the above embodiment may be modified so that a daytime running light room 203 is provided separately from the low-beam light room 3, and the hue of the light source 203b in the daytime running light room 203 is variable. That is, the light source 203b is used as a specific lamp exclusively used for daytime lighting.

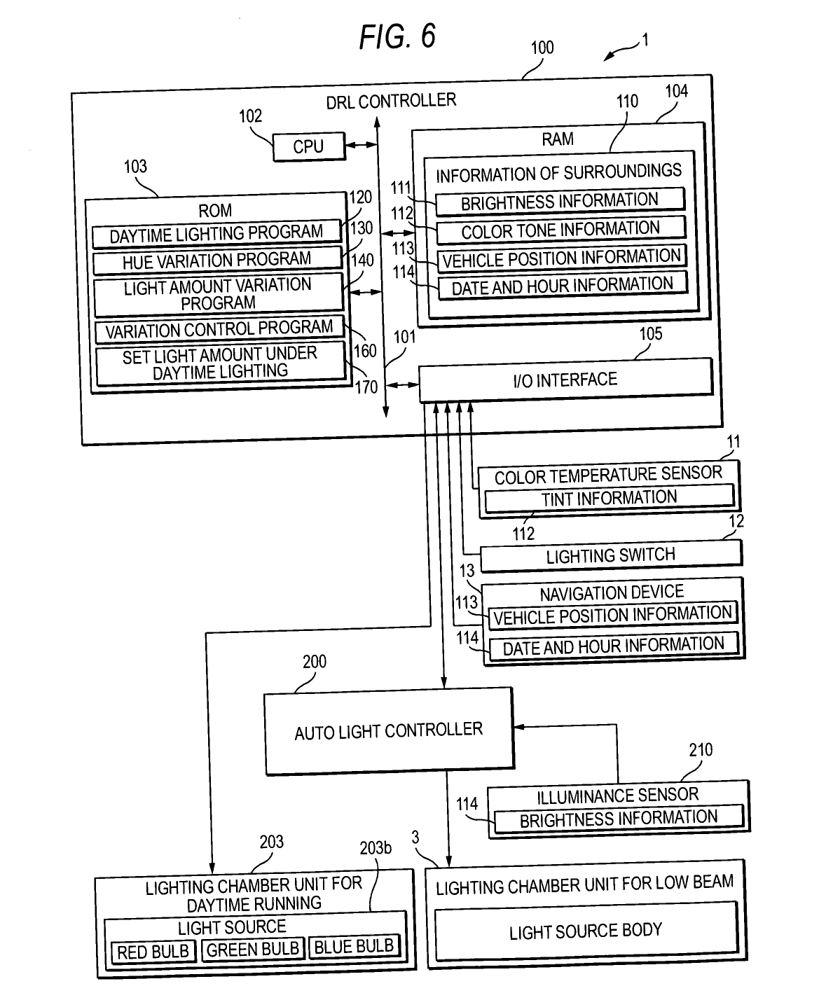

In this case, it is preferable that an automatic light control device 200 connected to the low-beam head lamp and the illuminance sensor 210 are commonly used as shown in FIG. 6. Accordingly, in addition to the same function and effect as the above embodiment, some parts can be commonly used, so that the manufacturing cost can be reduced and the weight of the vehicle can be reduced. In this case, the operation of the DRL controller 100 is the same as the above embodiment except that the control associated with the low-beam head lamp is carried out by the automatic light control device 200. No lamp turn-on program 150 is stored in ROM 103 of the DRL controller 100. As described above, the light source 203b is exclusively used for the daytime lighting, and thus the control of the lamp is relatively easy.

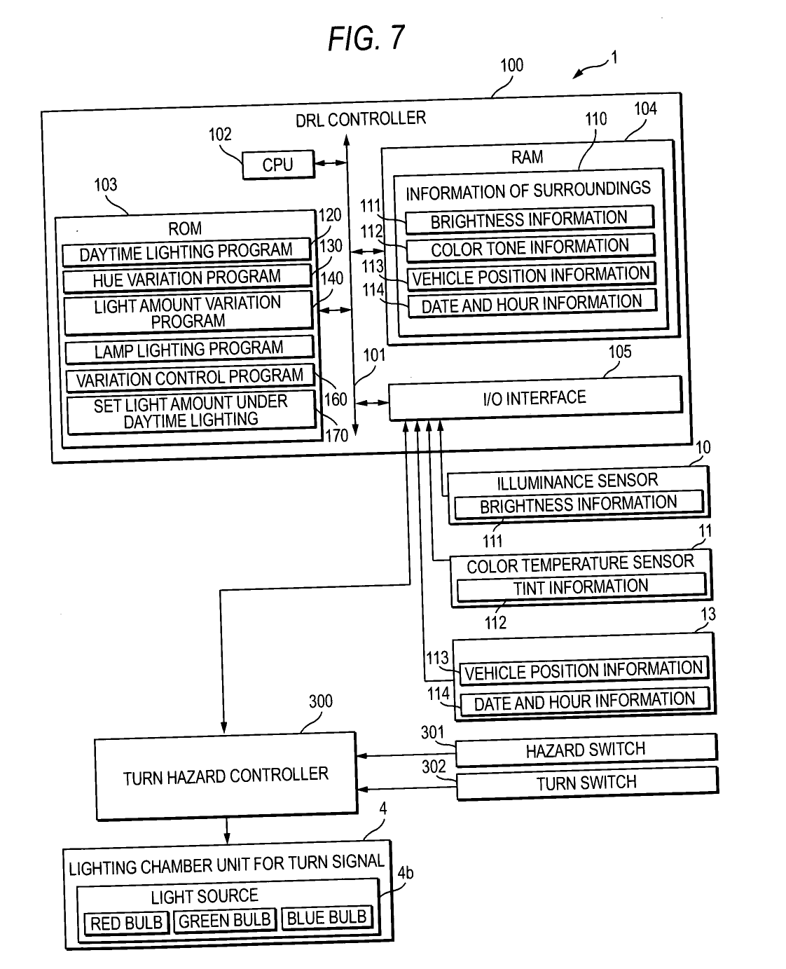

Furthermore, in the above embodiment, the daytime running lamp is commonly used as the low-beam head lamp. However, it may be also commonly used as the turn signal lamp or as the clearance lamp. When it is also commonly used as the turn signal lamp, a turn hazard controller 300 connected to a hazard switch 301 and a turn switch 302 is connected to the DRL controller 100 as shown in FIG. 7. The DRL controller 100 is connected to the light source 4b of the turn signal light room 4 in place of the light source 3b of the low-beam light room 3a to change the hue of the light source 4b. Accordingly, the light source 4b functions as the turn signal lamp in principle, and when it is not used as the turn signal lamp under the daytime running condition, it is turned on by the DRL controller 100.

When the daytime running lamp is also commonly used as the clearance lamp, the light source 5b functions as a clearance lamp in principle, and when it is not used as the clearance lamp under the daytime running conditions it is turned on by the DRL controller 100.

Furthermore, in the above embodiment, the DRL controller 100 achieves the vehicle position information 113 and the date and hour information 114 from the navigation device 13, however, the above embodiment may be modified so that the DRL controller 100 is not connected to the navigation device 13. In this case, the DRL controller 100 may directly receive these information from the outside of the vehicle, or these information may not be used to vary the hue of the light source 3b.

In the above embodiment, the hue varying program 130 varies the hue of the light source 3b on the basis of the color tone information 112, the vehicle position information 113 and the date and hour information 114. However, it is not necessarily required to achieve all these information 112 to 114, and the hue of the light source 3b may be varied on the basis of at least one of these information 112 to 114. For example, if the hue of the light source 3b is varied on the basis of only the date and hour information 114, the light source 3b is made to emit light with yellow-green color from 5 a.m. to 8 a.m., with yellow color from 8 a.m. to 3 p.m., with yellow-green color from 3 p.m. to 8 p.m., etc. Furthermore, the hue of the light source 3b may be varied on the basis of the brightness information 111.

Furthermore, in the above embodiment, the light source 3b comprises the three bulbs 3c of red, green and blue. However, if the light source 3b comprises bulbs 3c of yellow, light blue and purple, the light source can be made to emit light with all the colors. Here, even when the light source 3c comprises bulbs 3c of two colors, the hue can be changed. Furthermore, the light source 3c may comprise four or more bulbs 3c. The light emission portion is not limited to the bulb 3c, and it may be LED.

In the above embodiment, the variation amount of the light emission degree of each bulb 3c of the light source 3b is suppressed by the variation suppressing program 160. However, even when the same control state is continued for only a fixed time, the variation of the light emission state of the light source 3b due to the neon of street lamps, light of other cars or the like can be suppressed. Furthermore, for example, it maybe modified so that information concerning the neon of street lamps, light of other cards, etc. is stored in advance, and if the same information is detected, the light emission state of the light source 3b is not renewed.

Furthermore, the light amount control of each light emission portion which corresponds to the color temperature and the illuminance shown in FIGS. 4 and 5 can be suitably varied, and also the detailed structure, etc. may be suitably modified.

Although the invention has been explained according to the embodiments, it should also be understood that the invention is not limited to the embodiments and that various changes and modifications maybe made to the invention from the gist thereof.

What is claimed is:

1. A vehicle headlight device comprising:
a light source with a changeable hue;
a hue varying unit for varying the hue thereof on the basis of information of the surroundings of a vehicle; and
a daytime turn-on control unit for turning on the light source under a predetermined daytime running condition.

2. The vehicle headlight device according to claim 1, further comprising:
a color tone detecting unit for detecting the color tone of the surroundings wherein the information thereof contains information concerning the color tone detected by the color tone detecting unit.

3. The vehicle headlight device according to claim 1 wherein
the information of the surroundings contains the information concerning a date and a hour.

4. The vehicle headlight device according to claim 1 wherein
the information of the surroundings contains the information concerning the position of the vehicle.

5. The vehicle headlight device according to claim 1 wherein
the light source has a plurality of light emitting portions for emitting the light with a different hue, and the hue varying unit controls a color mixing state of the respective light emitting portions to vary the hue of the light source

6. The vehicle headlight device according to claim 1, further comprising:
a brightness detecting unit for detecting a brightness of the surrounding environment of the vehicle, and a light amount varying unit for varying the light amount thereof on the basis of the brightness detected by the brightness detecting unit.

7. The vehicle headlight device according to claim 1 wherein
the light source is a specific lamp turned on only in the daytime.

8. The vehicle headlight device according to claim 1 further comprising:
a lamp turn-on control unit for prohibiting the operation of the daytime turn-on control unit when a predetermined lamp is turned on, and turning on the light source as the specific lamp.

9. The vehicle headlight device according to claim 8, wherein
the specific lamp is a clearance lamp.

10. The vehicle headlight device according to claim 8 wherein
the specific lamp is a turn signal lamp.

11. The vehicle headlight device according to claim 8 wherein
the specific lamp is a low-beam head lamp.
